(19) United States
(12) Patent Application Publication
(10) Pub. No.: US 2007/0144976 A1
(43) Pub. Date: Jun. 28, 2007

(54) Micro-reactor

(76) Inventors: Matthias Franzreb, Karlsruhe (DE); Tilmann Rogge, Heidelberg (DE)

Correspondence Address: KLAUS J. BACH, 4407 TWIN OAKS DRIVE, MURRYSVILLE, PA, 15668, US

(21) Appl. No.: 11/711,188

(22) Filed: Feb. 26, 2007

(30) Foreign Application Priority Data
Dec. 24, 2004 (DE) 10 2004 4062534.4

(51) Int. Cl. B01L 3/00

(52) U.S. Cl. 210/695; 417/48; 436/174; 422/100

(57) ABSTRACT

In an arrangement for the transport of at least one magnetic particle fraction through a microfluidic system including a structure with micro-channels and means for generating a back and forth flow of fluid in the channels in which the magnetic particle fraction is contained for movement of the magnetic particles through the micro channels, means are provided for generating a magnetic field to be switched on while the fluid flows in one direction for fixing the magnetic particles and to be switched off while the fluid flows in the opposite direction so that the magnetic particles are carried along with the fluid when flowing in that direction.

This is a Continuation-In-Part Application of pending International Patent Application PCT/EP2005/013426 filed Dec. 14, 2005 and claiming the priority of German Patent Application 10 2004 4062 534.4 filed Dec. 14, 2005.

### BACKGROUND OF THE INVENTION

The invention resides in an apparatus for transporting at least one magnetic particle fraction through a microfluidic system via microfluidic channels provided with means for causing a fluid flow in the microfluidic channels.

Microfluidic systems are central handling systems for fluids such liquids or gases with or without solids in the micro- and nanotechnology used particularly in the field of life sciences or biomedical areas where nano-objects in the form of large biomolecules such as peptides or proteins must be handled [1]. Since direct handling of such small objects is rarely possible in the Life Science field often so-called beads are used. Beads are polymer bodies, mostly spheres with a functionalized surface onto which for example DNA or proteins are bound so that they can be handled for a synthesis or an analysis. In this growing field already today commercial apparatus are available in which an analysis can be performed on the basis of individual beads [2]. There are furthermore various analysis methods and apparatus on the basis of beads which have a high degree of polarization and operate with liquid volumes of as little as 10 microliters. Often for particular handling of such beads electric fields [3] or so-called laser [4] [5] are used. In rare cases, magnetic forces are used. In rare cases, magnetic forces are used in microtechnology, since these forces cannot easily be generated microtechnically. However, because of their small effects on biological materials and processes, magnetic forces would be particularly suitable [6].

Magnetic beads are used today in standard biochemistry procedures and are commercially available from several companies (for example, http://www.magnetiicmicrosphere.com/supply.htm). Such beads are generally available in super paramagnetic and also mono-dispersive form with diameters of 1 μm to 10 μm and are used for analysis and synthesis purposes. Magnetic microbeads can be handled to a large degree only with the aid of so-called high-gradient magnetic separators [7]. For smaller volumes, magnetic microbeads are separated or, respectively, fixed generally by simple permanent magnets on rare earth basis. This procedure however is very inflexible and requires for the release of the fixation always movable components which permit a spatial separation between the reaction container including the magnet beads and the permanent magnet. Substantially more flexible is a procedure, wherein the magnet beads are brought into the influence area of soft magnetic structures. For fixing the magnet beads, the structures are magnetized by an outer magnetic field. For releasing the magnet beads, the outer magnetic field only needs to be switched off, that is, no movable part is needed. A corresponding arrangement has already been developed for the separation of magnet beads from so-called micro-titer plates and has been patented (DE 10 057 396).

A critical point in working with biochemical materials in biological and pharmaceutical research are the high expences for substances some of which are made by expensive synthesis processes. The actual tests require only small amounts of materials particularly in connection with new analysis procedures (for example, Genechip® of the company Affymetrix, www.affymetrix.com), but an economical handling of the materials is difficult. Because of their small dead volume microfluidic systems would be well suitable for work with such materials. The advantage obtained thereby, however is lowered if, for the introduction of a new material into the microfluidic system, the system must be completely flushed.

It is therefore the object of the present invention to provide a microfluidic system in which particle fractions (beads) are conducted serially and in a certain direction through passages and reaction chambers without any net movement of the fluid carrying the particle fractions.

### SUMMARY OF THE INVENTION

In an arrangement for the transport of at least one magnetic particle fraction through a micro-fluidic system including a structure with micro-channels and means for generating a back and forth flow of fluid in the channels in which the magnetic particle fraction is contained for movement of the magnetic particles through the micro channels, means are provided for generating a magnetic field to be switched on while the fluid flows in one direction for fixing the magnetic particles and to be switched off while the fluid flows in the opposite direction so that the magnetic particles are carried along with the fluid when flowing in that direction.

Material transport in fluidic systems is generally achieved by movement of the fluid with the materials contained therein to the various locations.

The material transport in the apparatus according to the invention, however, does not occur by movement of the fluid but by a transport of the beads using the principle of a “fluidic ratchet”. By generating a retaining force during the movement of the fluid in one direction the beads can be fixed. “Ratchet” is the designation for a device, for example, a tool wherein a blocking structure prevents movement of an object only in one direction whereas in the opposite direction the object such as a screw or a belt is moved. The direction of movement may be reversible. The apparatus according to the invention concerns a microfluidic system in which particle fractions (beads) can be moved serially in a certain direction through passages and reaction chambers without large overall fluid movements. To this end, a small-scale fluid movement which causes a movement of the particles is combined with a switchable force (blocking force) which essentially fixes the particles or at least reduces the travel speed of the particles substantially during movement of the fluid in the opposite direction. The fluid movement may be generated mechanically or electrically (for example, by electro-osmosis). The blocking force can be generated by magnetic fields which act on the beads, by electric fields which are effective on the basis of dielectricity number differences between the fluid and the particles (dielectrophoresis, electrostatic) by optical fields which according to the laser tweeter generate diffraction effect forces, or, by electromechanically induced surface effect forces which act on the bead surfaces.

An actuator generates a periodic small-scale back-and-forth movement (freewheeling) of the fluid in the channel system. By generating an inhomogeneous magnetic field (blocking arrangement) during backward movement of the fluid the beads can be fixed during the backward movement of the fluid. As a result of the fixing of the beads during the backward movement of the fluid and the release during the forward movement, a movement of the beads through the channel system in one direction is obtained without over-all movement of the fluid. The direction of movement can be reversed.

Super paramagnetic particles are introduced into a fluidic channel system. As long as no other forces are effective on these particles, the particles are carried along with any movement of the fluid in the channel system. If, with a periodic movement of the fluid, the particles are prevented from moving in one direction, the particles are transported overall in the other direction. While the particles are retained, only the surrounding fluid moves in the opposite direction. The periodic movement of the fluid does not result in substantial mixing since in very small channel systems a turbulent flow can normally not occur. The volume of the reaction chambers is very small so that the needed amount of reactants is very small. Channel dimension of several micrometers and volumina of the reaction chambers in the nano-liter range are obtained.

Magnetic Forces

In order to generate a bead movement according to the principle of a fluidic ratchet, sufficiently large magnetic forces and suitable magnetic beads must be available.

The magnetic blocking force effective on the super paramagnetic particles should preferably be in the area of 10-100 pN, wherein the magnetic force on the particles is derivded on one hand from the volume and the susceptibility of the particles and, on the other hand, from the product of field strength times gradient of the magnetic field. While the achievable field strengths are in the area of a few Tesla, with soft magnetic microstructures high field gradients can be generated over short distances.

The magnetic retaining force is achieved by soft magnetic microstructures which directly adjoin the fluid area and distort on externally generated magnetic field. The very small lateral dimensions of these structures should correspond to the diameter of the beads used, whereas the vertical dimensions may be three to ten times that value. The structures are manufactured by resist structuring with masking technology by galvanic depositing. Subsequently, the structures are encased in plastic. The plastic herein fulfills two functions: First, a smooth flat surface is formed which does not affect the bead movement. Furthermore, the plastic serves as bond partner for the housing part with the fluidic channel structures.

Exemplary manufacture of a soft magnetic microstructure:

1. Depositing a galvanic starter layer on a substrate (silicon or glass)

2. Depositing a resist and structuring

3. NiFe—galvanic treatment

4. Applying an enveloping layer.

Essential for the use of magnetic forces in micrometer dimensions is the generation of highly inhomogeneous magnetic fields. It has been shown that already without soft magnetic microstructures, values>10 pN can be reached for 4 μm particles [9]. With the use of soft magnetic microstructures, the particles can be substantially smaller or the background magnetic field can be weaker. Suitable are, among others, soft magnetic structures of Permalloy (80% Ni and 20% Fe). For example, Permalloy columns with a diameter of 5 μm and a height of 90 μm may be produced by x-ray lithography and galvanic treatment with a saturation magnetization of 0.93T [10].

Fluidic System

The fluidic transport of particles through channels and along surfaces has been examined for many decades and is described in detail [11].

The particle movement herein depends, in addition to the geometric sizes and the effective surface forces, on the flow velocity of the fluid and can be realized with balls [12], but also with biological units such as cells [13]. If, with the periodic fluid movement, no turbulences develop, it is expected that the material transport within the fluid is not substantially larger than the diffusion speed. As shown by the extensive literature in the area of micro-mixers [14] [8] also an intended generation of turbulence is difficult to achieve in microfluidic systems. The arrangement according to the invention fulfills in this respect various requirements. The fluid movement must be large enough to move particles through the fluid. To achieve this, flow speeds of about 1-10 μm/s are required in the channel system. Herein, the speed of the particles in the fluid channels depends on the ratio of the channel size to the particle size, the fluid speed, the adhesion of the particles on the channel walls and the shape of the particles.

The fluid channels must be so shaped that a periodic fluid movement can easily be transmitted in the fluid structures. It is important that the system is sufficiently noncompressible so that it cannot elastically accommodate the fluid movement. Since the flow speed and, accordingly, the movement of the beads depends on the channel cross-section, the flow speed can also change within the system. A widening of the channels in the area of the reaction chambers, for example, increases the residence time. The filling of the reaction chambers and the continuous supply of reaction compounds is ensured by a slow fluid flow through the reaction chambers normal to the direction of the movement of the beads. This makes a complete exchange of the compounds contained in the reaction chambers possible.

The fluidic channels should have a cross-section corresponding about to the bead size. For example, with a bead size of 4 μm, the channel width and height should not be more than 10 μm. Structures with such dimensions can be produced by photographic x-ray lithographic procedures. Which process is most suitable depends on the required structure quality and the suitable plastic materials.

Microstructures can be produced in many ways: by optical lithography (SO8), polyimide), by hot stamping (mold manufacture by LIGA-processes or cutting procedures) or by x-ray depth lithography. Even highest requirements for structural dimensions, up to the submicrometer range, sidewall roughness with optical quality and aspect ratios of 20 and higher can be met.

Bonding

A bead movement generated by the fluid within the fluidic system requires a good propagation of the fluid movement within the fluid area. Air enclosures or deformations of the microstructures would disturb the propagation and must be avoided. Furthermore, variations in the channel geometry result in changes of the flow speed. Therefore, the manufacture of a pressure resistant bond joint with little variation in the bond area thickness is important. For plastic structures, bonding procedures are suitable wherein thin seal layers are formed by photo-degradation (see above) or by centrifugal application and are joined subsequently by pressure and heat in a corresponding bonding device.

With the bonding procedure, it is possible to manufacture also substantially smaller fluidic structures as it has been possible so far, with typical channel cross-sections of 50 μm×50 μm.

Actuator

For the construction of an apparatus according to the invention, a micro-fluid actuation mechanism is needed at least at one location. Operation with small amounts of material requires for example a dosing arrangement with rapid switching times. For both tasks, piezo-actuators are suitable. There is for example a piezo-actuated micro-valve with switching times of less than 2 ms [DE 199 49 912]. Its design makes it also suitable for the generation of a periodic stroke.

Those actuators have the advantage of short switching times (typically one millisecond) and can generate a large force. The mechanical movement can be directly coupled into the system or via a transmission system. Alternatively, actuators using compression spring systems or systems driven by electric motors via a motor shaft can be used.

Connection Concept Fluid Supply/Product Delivery

The operational principle of the apparatus according to the invention requires a periodic fluid movement which can be utilized efficiently only if the system is incompressible and a movable interface is provided only at the channel exit (gas bladder). This requires a rigid fluid supply or high flow resistances in the fluid supply area. Furthermore, a simple bead removal should be possible at any time. To this end, the beads are collected in at least one chamber and flushed out when necessary.

The synthesis of proteins, peptides and other substances is becoming more and more important in the last years. Herein, not only a cost effective manufacture of large material amounts is technically of interest but also methods for the flexible production of small material amounts wherein only minimal amounts of the mostly very expensive preproducts are required.

The required material amounts are only a few nanograms, so that even a simple prototype of a biosynthesis reactor is capable of producing sufficient amounts of substances. For this reason, a qualification and quantification of the synthesis reaction is possible by variation of the process parameter. With a Merrifield solid phase synthesis (AMS) adapted to magnetic beads certain desired peptides are produced. With beads provided with specific cleavable spacers which carry at their ends the start-out molecules for the AMS, with the apparatus according to the invention, the AMS is performed up to the desired peptide length. To this end, the beads are moved through the various reaction areas of the apparatus. The arrangement according to the invention permits for those applications where only small material amounts are required a rapid synthesis of complex molecules which requires little material, for example, peptides, proteins, oligo nucleotide, DNA, oligo saccharide or RNA whose synthesis can be accomplished by successive individual reactions. Small material amounts, but in large variations, is required for example in the field of searching for effective compounds and in the development of pharmaceutical and biomedical substances. stances.

With the use of apparatus according to the invention, the amount of substances and the time required for obtaining the substances needed for determining the sequences of proteins or DNA sections can be further reduced. To this end, the proteins or the DNA sections are attached to beads and are stepwise analyzed as they pass through the various reaction tion chambers. The apparatus according to the invention can be expanded in the process by additional components for detection, for example, magneto-electrically [16], by (integrated) optical systems [2] or electrochemically [17]. Also, a combination of synthesis, reaction and analysis can be performed with the apparatus according to the invention. For example, in a first area, molecules can be synthesized which, in a subsequent area, are exposed to various substances and are then directly analyzed.

Furthermore, sensors may be arranged in the reaction chambers or introduced into the fluid channels in order to control the reactions more precisely.

The invention will become more readily apparent from the following description of exemplary embodiments with reference to the accompanying drawings.

### BRIEF DESCRIPTION OF THE DRAWINGS

FIG. 1a to FIG. 1c show the system elements and the principle for a magnetic ratchet,

FIG. 2 shows an exemplary microstructure for generating an inhomogeneous magnetic field,

FIG. 3 shows the exemplary manufacture of soft magnetic microstructures,

FIG. 4 shows the exemplary manufacture of a fluid structure,

FIG. 5 shows the exemplary preparation of a bond connection, and

FIG. 6 shows an exemplary arrangement of an apparatus according to the invention.

### DESCRIPTION OF EXEMPLARY EMBODIMENTS

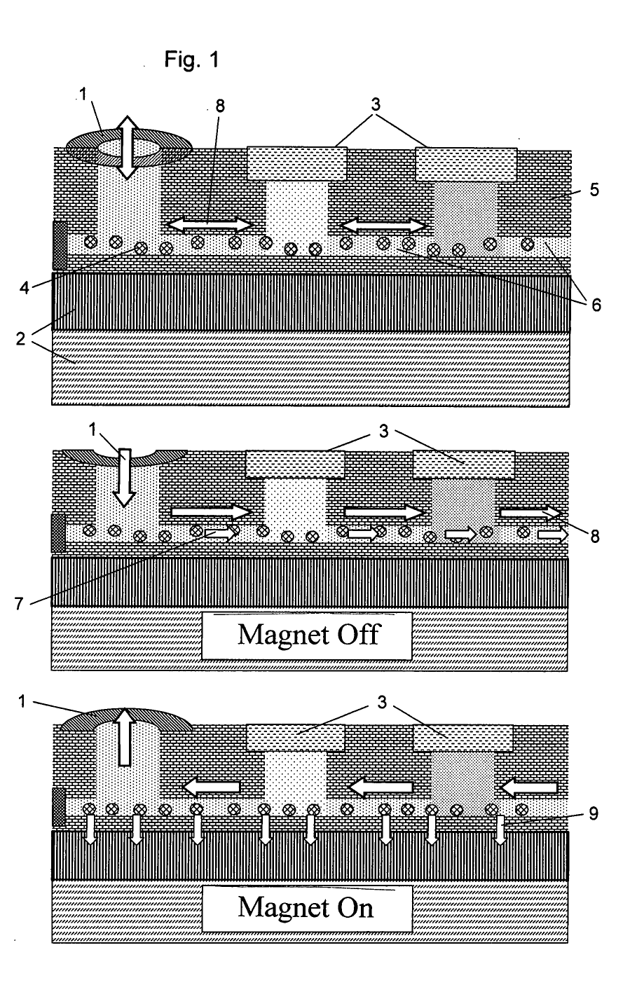

FIGS. 1a to 1c show in cross-sectional views, the essential elements and the operating principle of a fluidic ratchet. It includes an actuator 1 for generating a fluid flow 8 in the fluid channels 6. The fluid flow 8 moves the beads 4. It also includes a mixing chamber volume 3 and a micro-structured soft iron magnet core 2 for generating a magnetic blocking force. The arrangement is closed up by a housing wall 5. Depending on the direction of operation of the actuator 1, the fluid 8 moves through the passages 6 in a particular direction 7 and the beads 4 are moved by the fluid. When the blocking force is switched on, the beads are retained in contact with the wall 5 by the magnetic forces 9.

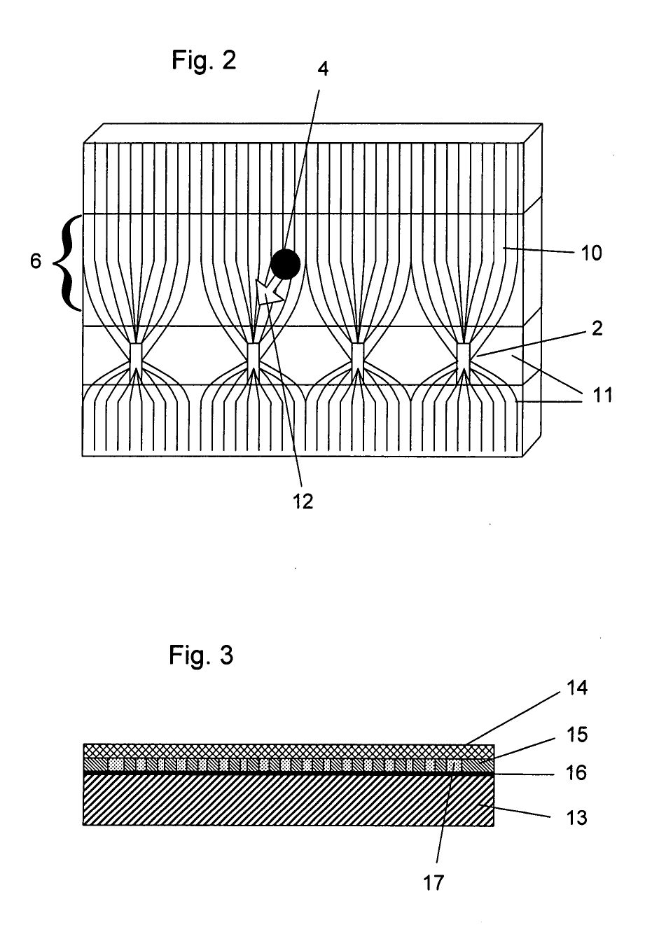

FIG. 2 is a schematic cross-sectional view showing the field lines 10 of a switched on inhomogeneous magnetic field as generated by a soft iron micro-structured magnetic core 2, which is embedded in plastic 11. The magnetic beads 4 are moved in the fluid filled channel 6 toward the magnet core 2 in the direction 12 and retained thereby.

FIG. 3 shows schematically an example for the manufacture of the soft magnetic microstructure wherein, on the substrate 13 (for example of silicon or glass), a galvanic starter layer 16 is deposited, then a resist 15 is applied and is structured by openings 17 and then galvanically treated for example by Permalloy (NiFe) at a ratio of 80/20) and then a sealing layer 14 is applied.

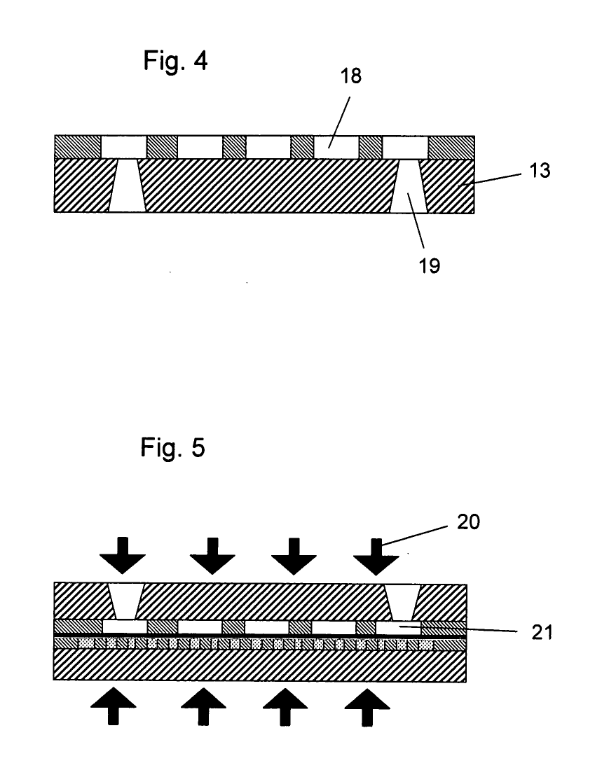

FIG. 4 shows schematically an exemplary manufacture of a microfluidic channel structure 18. The substrate 13 is provided with openings 19 for the introduction of fluid. The openings can be formed mechanically (for example, by boring or laser cutting) by wet chemical procedures or by reactive ion etching. The groove structures are prepared by structuring (stripping) of the resist deposited on the substrate (for example, SU8, PMMA, polyimide).

FIG. 5 shows the procedure for bonding the structures provided in FIG. 3 and FIG. 4, by application of pressure forces and heat (arrows 20), whereby microfluidic channel structures 21 are provided.

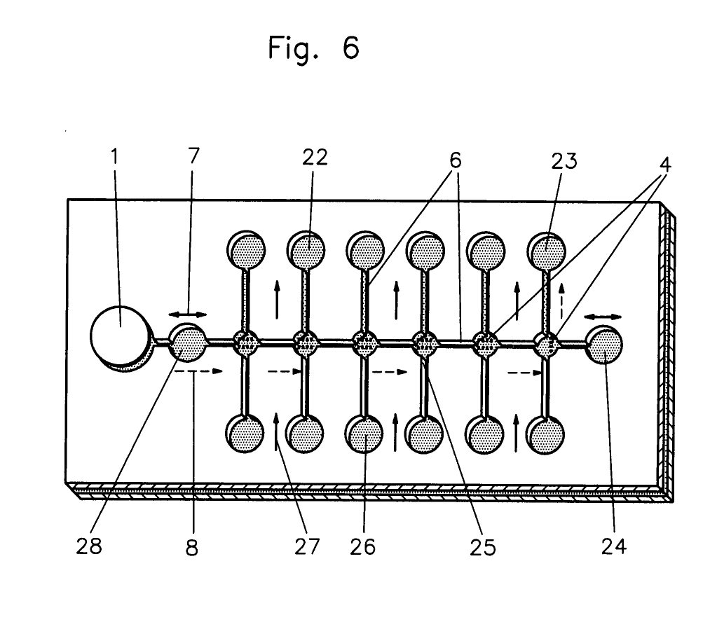

FIG. 6 shows an exemplary embodiment of an apparatus according to the invention consisting of a micro-structured magnet, a microfluidic channel structure, an actuator and fluidic connections.

The top view of this system shows the fluidic structures. The periodic fluid movement 7 needed for the transport of the beads 8 is generated by an actuator 1, which is disposed at the beginning of the fluid system. The beads are introduced into the system via an opening 28 and are moved through the microfluidic channel in accordance with the ratchet principle [FIG. 1]. A compensation chamber 24 at the end of the fluid structure with a certain fluid level so as to provide resiliency makes the periodic movement possible. In the mixing chamber, volume 25, the residence time of the beads 4 can be controlled by the geometric shape as column structures guide the beads 4 in that area. In the last mixing chamber volume 23 of the system, the beads are collected and flushed out when desired. In the mixing chamber volume 25, the reaction compounds are added in a direction normal to the bead movement direction 27 via the microfluidic fluid supply. Via the inlet 26 and the junction 22, the filling of the chambers is facilitated and a continuous control of the material concentration is made possible.

Listing of References

[1] Chih-Ming Ho, Fluidics—the link between micro and nano sciences and technologies, MEMS 2001, Interlaken, Switzerland, Jan. 21-25, 2001.
n[2] Sherry A. Dunbar, Coe A. Vander Zee, Kerry G. Oliver, Kevin L. Karem and James W. Jacobson, Quantitative, multiplexed detection of bacterial pathogens: DNA and protein applications of the Luminex LabMAP™ system, Journal of Microbiological Methods, Volume 53, Issue 2, May 2003, Pages 245-252.
[3] Michael Pycraft Hughes, Nanoelectromechanics in Engineering and Biology, 2003, Boca Raton, London, New York, Washington, D.C. CRC Press LLC.
[4] G. Romano, L. Sacconi, M. Capitanio and F. S. Pavone, Force and torque measurements using magnetic micro beads for single molecule biophysics, Optics Communications, Volume 215, Issues 4-6, 15 Jan. 2003, Pages 323-331.
[5] Sibani L. Biswal and Alice P. Gast, Mechanics of semiflexible chains formed by polyethylene glycol-linked paramagnetic particles, Physical Review E 68, 021402 (2003).
[6] D. Niarchos, Magnetic MEMS: key issues and some applications, Sensors and Actuators A: Physical, Volume 106, Issues, 1-3, 15 Sep. 2003, Pages 255-262.
[7] C. Hoffmann, M. Franzreb, W. H. Höll, “A novel high gradient magnetic separator (HGMS) design for biotech applications plications”, IEEE Trans. on Appl. Superconductivity, 12, No. 1, 2002, Pages 963-966.
[8] H. Suzuki and C. M. Ho, A Magnetic Force Driven Chaotic Micro-Mixer, Proc. 15th IEEE Int. Conf. MEMS'02, Las Vegas, (2002), Pages 40-43.
[9] Jin-Woo Choi, Chong H. Ahn, Shekhar Bhansali and H. Thurman Henderson, A new magnetic bead-based, filterless bio-separator with planar electromagnet surfaces for integrated bio-detection systems, Sensors and Actuators B: Chemical, Volume 68, Issues 1-3, 25 Aug. 2000, Pages 34-39.
[10] A. Thommes, W. Stark, W. Bacher, Die galvanische Abscheidung von Eisen-Nickel in LIGA-Mikrostrukturen, FZKA 5586, Wissenschaftliche Berichte, Forschungszentrum Karlsruhe GmbH, Karlsruhe, 1995.
[11] Ronald F. Probstein, Physicochemical hydrodynamics, John Wiley&Sons Inc., New York Chichester Brisbane Toronto Singapore, 19952.
[12] Q. Han and J. D. Hunt, Particle pushing: critical flow rate required to put particles into motion, Journal of Crystal Growth, Volume 152, Issue 3, 1 Jul. 1995, Pages 221-227.
[13] Cheng Dong and Xiao X. Lei, Biomechanics of cell rolling: shear flow, cell-surface adhesion, and cell deformability, Journal of Biomechanics, Volume 33, Issue 1, Jan. 2000, Pages 35-43.
[14] St. Ehlers, K. Elgeti, T. Menzel and G. Wieβmeier, Mixing in the offstream of a microchannel system*1, Chemical Engineering and Processing, Volume 39, Issue 4, July 2000, Pages 291-298.
[15] T. Rogge, Z. Rummler, W. K.Schomburg, Entwicklung eines piezogetriebenen Mikroventils—von der Idee bis zur Vorserienfertigung, FZKA 6671, Wissenschaftliche Berichte, Forschungszentrum Karlsruhe GmbH, Karlsruhe, 2001.
[16] M. M. Miller, P. E. Sheehan, R. L. Edelstein, C. R. Tamanaha, L. Zhong, S. Bounnak, L. J. Whitman and R. J. Colton, A DNA array sensor utilizing magnetic microbeads and magnetoelectronic detection, Journal of Magnetism and Magnetic Materials, Volume 225, Issues 1-2, 2001, Pages 138-144.
[17] Joseph Wang, Nanoparticle-based electrochemical DNA detection, Analytica Chimica Acta, In Press, Corrected

What is claimed is:

1. An arrangement for the transport of at least one magnetic particle fraction through a microfluidic system, comprising:
a) a structure including at least one microfluidic channel carrying a fluid including the magnetic particle fraction,
b) means for generating a fluid flow axially within the microfluidic channel alternatively in opposite flow direction in accordance with two opposite switching positions,
c) means for generating a magnetic field in the channel for a temporary fixing of the magnetic particle fraction in one of the two switching positions, said switching positions alternating so as to cause back and forth flow of the fluid in the microfluidic channel and said means for generating a magnetic field being switched on in one switching position in order to fix the magnetic particles and being switched off in the other switching position to permit movement of the particles together with the fluid.

2. The arrangement as claimed in claim 1, wherein the microfluidic channel extends over its full length along a soft magnetic material.

3. The arrangement as claimed in claim 1, wherein the microfluidic system is at least partially formed into a substrate by one of optical lithography, hot punching, injection casting and x-ray lithography.

4. The arrangement as claimed in claim 1, wherein the microfluidic system is closed by a top cover plate in a form-locking manner.

5. The arrangement as claimed in claim 4, wherein the cover plate includes at least two openings, which are in communication with each other by way of the microfluidic channel.

6. The arrangement as claimed in claim 1, wherein the means for generating the fluid flow comprises an actuator which is in direct contact with the fluid.

7. The arrangement as claimed in claim 6, wherein the actuator is one of a. piezo bending actuator and a pressure spring system.

8. The arrangement as claimed in claim 1, wherein the microfluidic channel includes at least one of an inlet and outlet for another fluid.

9. The use of an arrangement according to claim 1 for performing a solid phase synthesis with a magnetic particle fraction.

10. The use of an arrangement according to claim 1, for bioanalysis using bio-molecules fixed on at least one magnetic particle fraction.

11. The use of the arrangement according to claim 10 for bio-analysis using bio-molecules fixed to at least one magnetic particle fraction.

12. The use of the arrangement according to claim 11, wherein the bio-molecules comprise proteins, peptides, DNA, RNA and cells that is, one of prokaryotic and eukaryotic cells.

13. The use of an arrangement according to claim 1 for a chemical analysis or manufacture including one chemical reactant or catalyst fixed to at least one magnetic particle fraction.
